(19) United States
(12) Patent Application Publication
(10) Pub. No.: US 2017/0282046 A1
(43) Pub. Date: Oct. 5, 2017

(54) Pressurized Injectable Mouthpiece

(71) Applicant: Clarence Patrick Wheeler, Atlanta, GA (US)

(72) Inventor: Clarence Patrick Wheeler, Atlanta, GA (US)

(21) Appl. No.: 15/446,263

(22) Filed: Mar. 1, 2017

Related U.S. Application Data
(60) Provisional application No. 62/499,675, filed on Feb. 2, 2017.

(51) Int. Cl. A63B 71/08; A61J 7/00

(52) U.S. Cl. CPC A63B 71/081; A61J 7/0015

(57) ABSTRACT

An pressurized injectable mouthpiece for athletes. The invention is configured to be pressurized and injected to suit users that uses this type of equipment. The pressurized injectable is inserted into the users mouth pressure is applied by biting down on the unit the inside is then coated with fluid/supplements depending on the amount of pressure applied. The invention includes a open and closeable tab at the front of the housing of the unit. Suction vents/air pockets are also available.

### CROSS-REFERENCES TO RELATED APPLICATION

Not Applicable.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

### 1. Field of the Invention

This invention generally to an pressurized injectable mouthpiece for athletes in sports such as football, basketball, soccer, boxing, and many more. More specifically, the invention relates to stand which a pressurized injectable mouthpiece can be injected properly with any type of approved or preferred supplement of the user choice.

### 2. Description of the Related Art

Their are many known different types of mouthpiece known to man as of today. Most of these are regular mouthpieces then you have some with lip guards attached these are the only two type of mouthpieces known at this present day. This level of sophistication has not been used in the field of the sports world. The present invention seeks to provide such a simple sophisticated way of injecting a mouthpiece.

### BRIEF SUMMARY OF THE PRESENT INVENTION

The present invention comprises a method of injecting a mouthpiece. The invention is configured to be injectable with an supplement preferred by an individual. The invention includes a open and closeable tab at the front of the mouthpiece. Mini suction vents/air pockets are indented on the inner base of the mouthpiece for easy access to whatever is injected into the mouthpiece as well. The entire unit is pressurized to suit the flow of whatever type of supplement is inside of the mouthpiece. For example, the harder you chew/bite down on the unit more supplements are released, the lesser you chew/bite down on the unit the lesser supplements are released into the user mouth. That way this feature includes the ability to vary the speed as well as amount of supplements being released from the mouthpiece and pulled back into the mouthpiece. This controlled pressurized feature preferably made to suit individuals tastes as well as flow ratio. This is all controlled through the amount of pressure applied to the mouthpiece.

### BRIEF DESCRIPTION OF THE SEVERAL VIEWS OF THE DRAWINGS

These and other features and advantages of the present invention will become more readily appreciated as the same becomes better understood by reference to the following detailed description when considered in connection with the accompanying drawings, wherein;

FIG. 1. is a fragmentary perspective view of the present invention showing the mouthpiece, the open and closeable tab at the front of the unit as well as the suction vents/air pockets.

FIG. 2 is a fragmentary perspective view of the present invention, showing the open/closeable tab in the open position and injection hole.

### REFERENCES NUMERALS IN THE DRAWINGS

1. Present Invention (Mouthpiece)
2. Open/Closeable Tab
3. Suction Vents/Air Pockets
4. Injection Hole

### DETAILED DESCRIPTION OF THE INVENTION

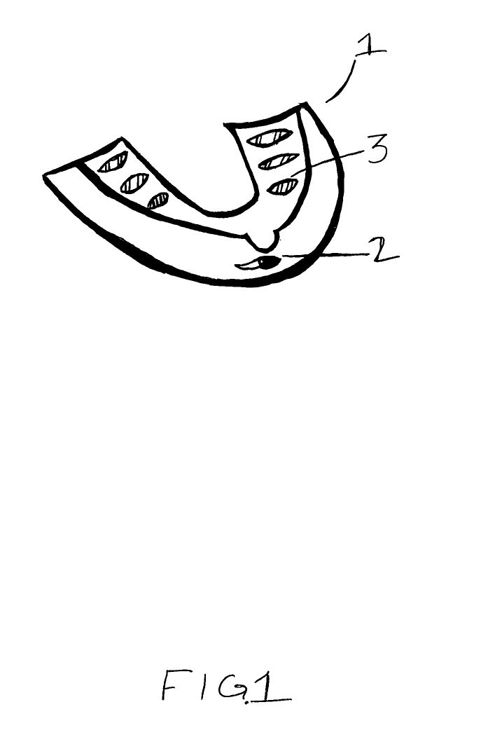

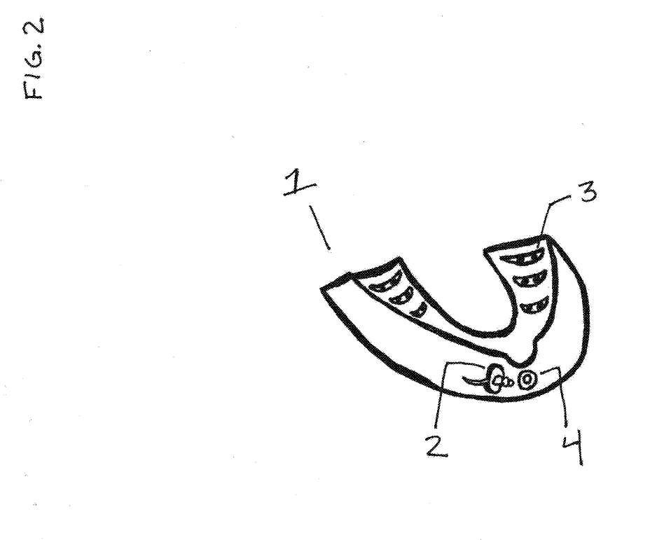

Referring to FIGS. 1 & 2, wherein like numerals indicated like or corresponding features throughout the view, a exemplary mouthpiece is generally shown at 1. For purpose of illustration and not to be in any way limiting. Injectable mouthpiece 1 includes open/closeable tab at 2, suction vents/air pockets at 3. It is configured to be injectable customarily for supplements for individuals use. Open and closeable tab at 2, this tab designed to open and close, allowing the mouthpiece 1 to be injected and preventing fluids from escaping the present invention. This can be achieved by firmly pressing the tab 2 into the injection hole 4 on the housing of the mouthpiece 1 (explained subsequently). Several suction vents/air pockets at 3 are indented on portions of the unit. These open and close periodically depending on the amount of pressure applied to the unit releasing as well as intakeing supplements. Onto FIG. 2, here you see the present invention 1, with the tab 2 in the open position, as well as the injection hole at 4 for injecting supplements into. That's the advantages of the present invention which includes it to be injectable and the pressurized option of how much fluids are released—as explained subsequently. The invention allows the user to determine the own intake of supplements depending on pressure applied to the unit. As many users will wish to configure the unit to suit their particular taste, with this control. The invention is simply controlled by biting down on the unit very hard applying firm pressure which in return will release and coat the inside of the unit with more supplements, as you release pressure remaining supplements are sucked back into the unit pretty simple.—Although the preceding description contains significant detail, it should not be construed as limiting the scope of the invention but rather as providing illustrations of the preferred embodiment of the invention.

Having described my invention, I claim:

1. An pressurized injectable mouthpiece is pressurized, configured to be injected, including a open and closeable tab and suction vents air pockets comprising:
a. a open and closeable tab at the front of the housing of the said unit to be injected;
b. suction vents/air pockets indented into the inside of the unit to to release fluids/supplements;

1. An pressurized injectable mouthpiece as recited in claim 1, further comprising at lease one open and closeable tab at the front of housing of unit.

2. An pressurized injectable mouthpiece as recited in claim 1, further comprising indented suction vents/air pockets on the inside of the unit.

3. An pressurized injectable mouthpiece as recited in claim wherein said is able to withstand being injected with a supplement.
